(19) United States
(12) Patent Application Publication
(10) Pub. No.: US 2008/0227316 A1
(43) Pub. Date: Sep. 18, 2008

(54) ELECTRICAL CONNECTOR

(75) Inventor: Ted JU, Anloku (TW)

Correspondence Address: MORRIS MANNING MARTIN LLP, 3343 PEACHTREE ROAD, NE, 1600 ATLANTA FINANCIAL CENTER, ATLANTA, GA, 30326, US

(73) Assignee: LOTES CO., LTD, Anloku (TW)

(21) Appl. No.: 11/943,754

(22) Filed: Nov. 21, 2007

(30) Foreign Application Priority Data
Mar. 15, 2007 (CN) 200720141689.5

(51) Int. Cl. H01R 13/44; H01R 13/62

(52) U.S. Cl. 439/133; 439/152; 439/153

(57) ABSTRACT

The electrical connector of the invention includes an insulative body and a plurality of conductive terminals. The insulative body has a plurality of terminal receiving passages accommodating the conductive terminals. The electrical connector further includes a shell, and the shell connects to the insulative body to form a mating port. The conductive terminals can be assembled on the electrical connector of the invention from a front direction and a back direction, even from an up direction and a down direction. Accordingly, the electrical connector of the invention can be with better performance, and the cost is lowered.

### BACKGROUND OF THE INVENTION

1. Field of the Invention

The present invention relates to an electrical connector.

2. Description of the Prior Art

So far, a mating port of an electrical connector is directly configured on an insulative body of the electrical connector, and terminals are assembled into the insulative body from back of it, such that contacting parts of the terminals enter the mating port for contacting with a mating electrical component. The assembly method of the terminals as described proceeding requires the insulative body formed with high channels. But the disposition of the high channels makes the design of the electrical connector difficulty. Particularly, when a connector has a contacting parts with a long and complex shape, and it must sacrifice some performances to facilitate assembly.

Therefore, it is very necessary to design a novelty electrical connector to solve the aforesaid problems.

### SUMMARY OF THE INVENTION

A scope of the invention is to provide an electrical connector capable of maintaining its better performance. For above purpose, the electrical connector of the present invention includes an insulative body formed with a plurality of terminal receiving passages, a plurality of conductive terminals received in the terminal receiving passages and a shell cooperating with the insulative body to form a mating port.

Compared with the prior art, in the present invention, the conductive terminals not only can be assembled into the electrical connector from front of the insulative body, but also from back of the insulative body, even can be assembled into the electrical connector from top or bottom of the insulative body. Accordingly, the electrical connector of the present invention can be with better performance and lower cost.

### BRIEF DESCRIPTION OF THE APPENDED DRAWINGS

FIG. 1 is a stereoscopic diagram illustrating an insulative body of the electrical connector of the invention.

FIG. 2 is a stereoscopic diagram illustrating the insulative body shown in FIG. 1 in another direction.

FIG. 3 is a stereoscopic diagram illustrating the insulative body shown in FIG. 1 with terminals assembled.

FIG. 4 is a stereoscopic diagram illustrating FIG. 3 in another direction.

FIG. 5 is a stereoscopic diagram illustrating a first terminal.

FIG. 6 is a stereoscopic diagram illustrating a second terminal.

FIG. 7 is a stereoscopic diagram illustrating the insulative body shown in FIG. 3 after being melted.

FIG. 8 is a stereoscopic diagram illustrating FIG. 7 in another direction.

FIG. 9 is a cross section of a part of FIG. 8.

FIG. 10 is another cross section of a part of FIG. 8.

FIG. 11 is a cross section of FIG. 8.

FIG. 12 is a stereoscopic diagram illustrating a shell of the electrical connector of the invention.

FIG. 13 is a stereoscopic diagram illustrating FIG. 12 in another direction.

FIG. 14 is a cross section of FIG. 12.

FIG. 15 is a stereoscopic diagram illustrating the electrical connector of the invention.

FIG. 16 is a stereoscopic diagram illustrating FIG. 15 in another direction.

FIG. 17 is a cross section of FIG. 15 along line b-b.

FIG. 18 is a cross section of FIG. 16 along line d-d.

FIG. 19 is a stereoscopic diagram illustrating an electrical connector according to the second embodiment of the invention.

FIG. 20 is an explosive diagram illustrating the electrical connector shown in FIG. 19.

FIG. 21 is an explosive diagram illustrating the FIG. 20 in another direction.

FIG. 22 is a stereoscopic diagram illustrating the shell of the electrical connector shown in FIG. 19.

FIG. 23 is an explosive diagram illustrating an electrical connector according to the third embodiment of the invention.

FIG. 24 is an enlarged diagram illustrating a part of the electrical connector shown in FIG. 23.

FIG. 25 is an assembly diagram illustrating the electrical connector shown in FIG. 23.

FIG. 26 is a stereoscopic diagram illustrating FIG. 25 in another direction.

FIG. 27 is a stereoscopic diagram illustrating a terminal blank of the electrical connector according to the third embodiment of the invention.

### DETAILED DESCRIPTION OF THE INVENTION

The advantage and spirit of the present invention may be well understood by the following recitations together with the appended drawings.

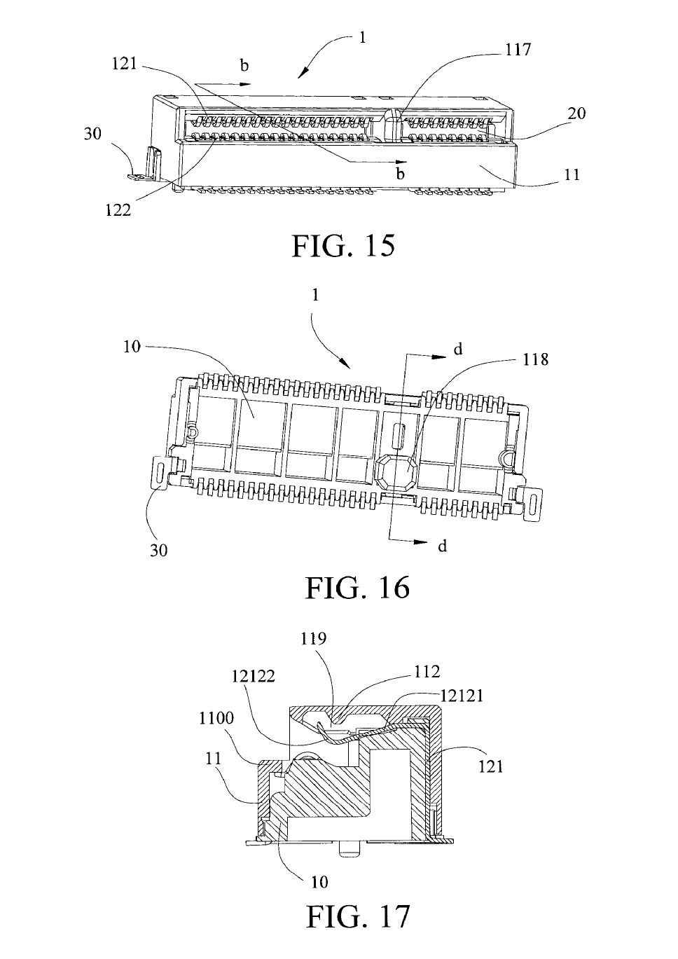

Please refer to FIG. 15 and FIG. 16. The electrical connector 1 of the present invention includes an insulative body 10, a shell 11 mated with the insulative body 10, and a plurality of terminals disposed between the insulative body 10 and the shell 11.

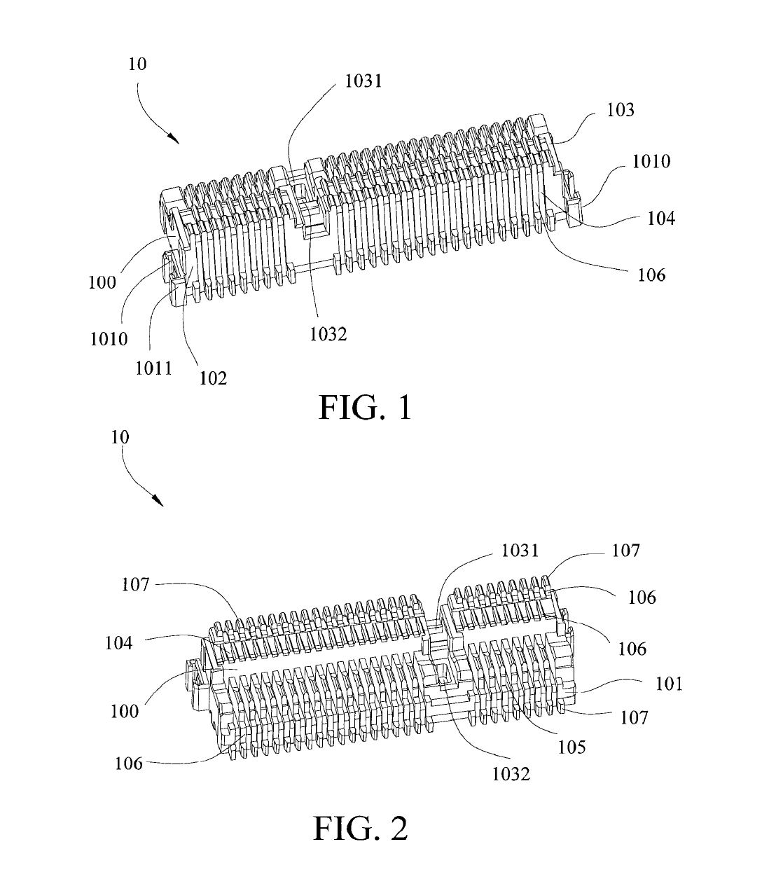

Please refer to FIG. 1 and FIG. 2. The insulative body 10 includes a base 100. The base 100 has a front end surface 101, a back end surface 102, and a top surface 103. The base 100 is also formed with terminal receiving passages on the front side, back side and top side thereof. First terminal receiving passages 104 are disposed on the back end surface 102 and the top surface 103; meanwhile, second terminal receiving passages 105 are disposed on the front end surface 101. Multiple separation barriers 106 are disposed both between the adjacent first terminal receiving passages 104 and between the adjacent second terminal receiving passages 105. Each of the separation barriers is formed with a protruding part 107. The protruding parts 107 can be used as fixing structures for holding terminals by melting, which will be described in detail later. A receiving passage 1031 is disposed on a place deviating from the middle of the top surface 103 of the insulative body 10 in a distance. The receiving passage 1031 has a channel 1032 passing through the insulative body 10. Fixing parts 1010 are disposed on two sides of the insulative body 10. A lock socket 1011 is disposed on each of the fixing parts 1010 and connects to the fixing device 30 (as shown in FIG. 15 and FIG. 16). The fixing device 30 is soldered on the circuit board (not shown in figures) so as to mount the insulation boy on the circuit board.

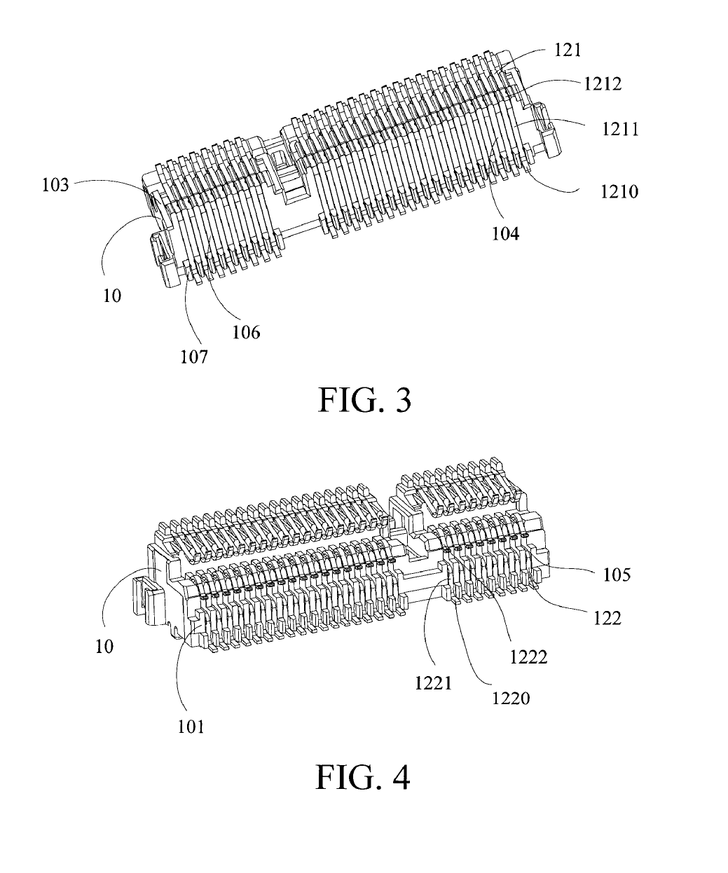

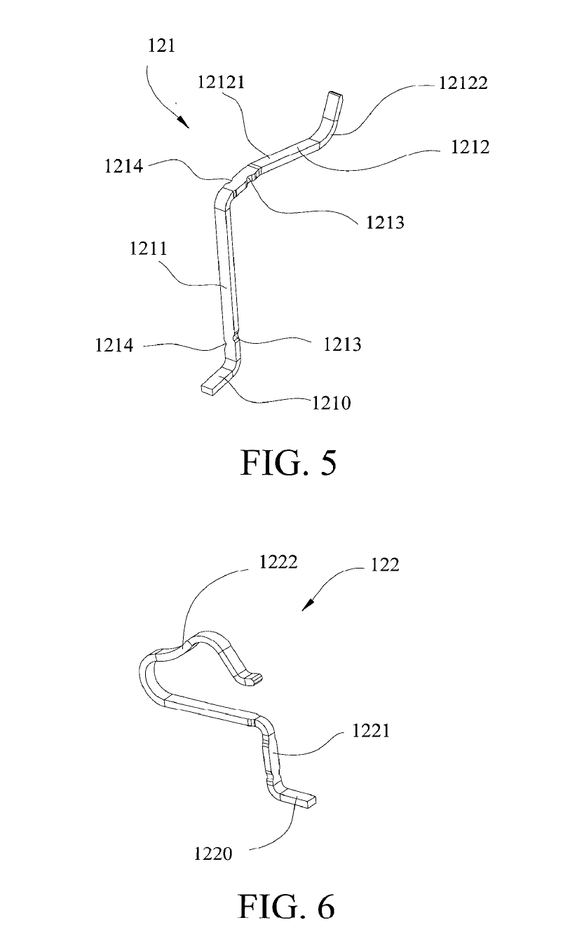

Please refer to FIG. 3-6. The terminals include first terminals 121 and second terminals 122. The first terminals 121 respectively include a first connecting part 1210, a first body part 1211 extending from the first connecting part 1210, and a first contacting part 1212 extending from the first body part 1211. The first contacting part 1212 includes a conducting arm 12121 connecting to the first body part 1211 and a conducting part 12122 bended and extending from the conducting arm 12121. The conducting part 12122 is disposed at an end of the conducting arm 12121 and is able to conduct with an external electrical component such as an electrical card (not shown). The first terminal 121 is accommodated in the first terminal receiving passage 104. The first body part 1211 is accommodated in the terminal receiving passage on the back end surface 102, and the first contacting part 1212 is accommodated in the terminal receiving passage on the top surface 103. The second terminal 122 includes a second connecting part 1220, a second body part 1221 extending from the second connecting part 1220, and a second contacting part 1222 extending from the second body part 1221. The second terminal 122 is accommodated in the second terminal receiving passage 105. Therein, the second body part 1221 is accommodated in the second terminal receiving passage 105 on the front end surface 101. Both the first body part 1210 of the first terminal 121 and the conducting arm 12121 of the first contacting part 1212 all have a first concave part 1213 and a second concave part 1214. The first concave part 1213 and the second concave part 1214 are interlaced with each other and are not to be opposite to each other, so as to prevent the terminal from cracking. The first and second terminals 121,122 are assembled on the insulative body to form two terminal rows on the up and down side.

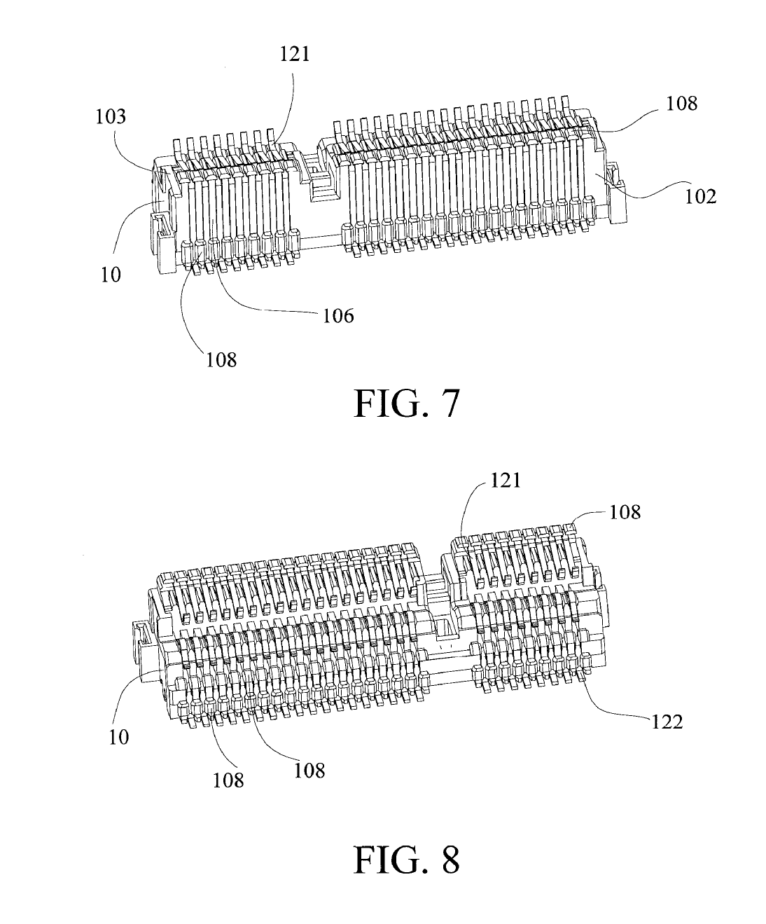

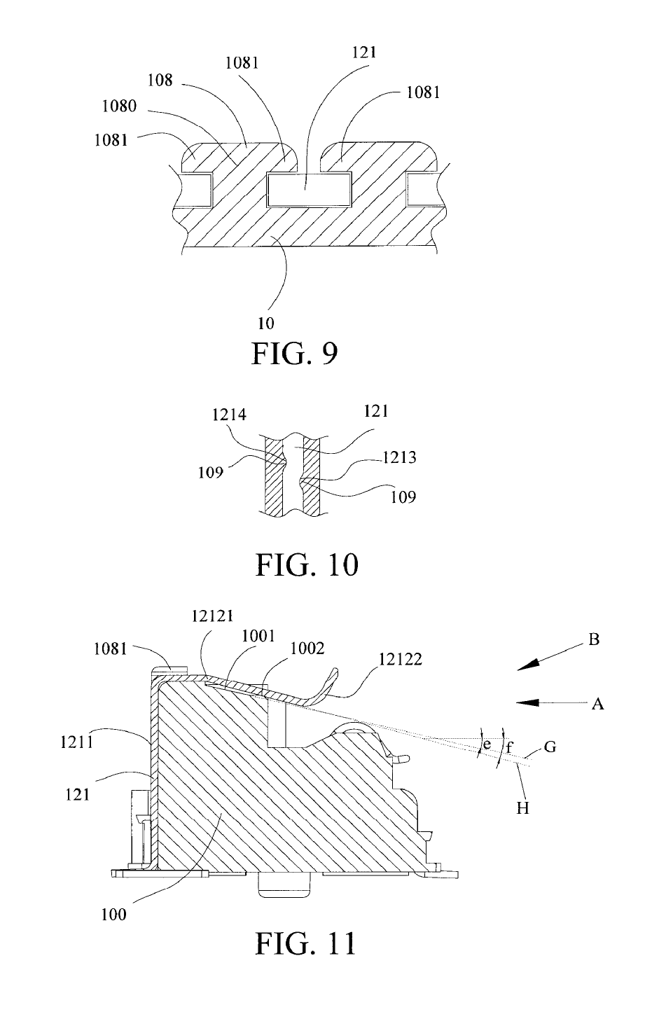

Please refer to FIG. 7-10. As described proceeding, the protruding part 107 can form a fixing structure to fix terminal by melting. As shown in FIG. 7 and FIG. 8, the protruding part 107 has been melted and formed the fixing structure 108 to the terminal by a supersonic wave, a high temperature or other methods. That is, ends of the separation barriers 106 extend toward the terminal and form the fixing structure 108, and cross section of the fixing structure 108 is a mushroom shape. The fixing structure 108 includes a protruding part 1080 disposed beside the terminal and a fixing block 1081 disposed above the terminal and laterally extending from both sides of the protruding part 1080 toward the terminal. The end of the fixing block 1081 does not extend beyond the middle of the terminal. The adjacent fixing blocks 1081 of the two adjacent fixing structures 108 together fix the same terminal, such that the terminal can be fixed firmly. The fixing structure 108 on the top surface 103 is at the area of the first body part 1211 of the first terminal 121 close to the first connecting part 1210, and the fixing structure 108 on the back side 102 is at the area of first contacting part 1212 close to the first body part 1211. The conducting arm 12121 and the first body part 1211 on the base are fixed below the fixing structure 108, such that the first terminal is fixed on the insulative body. The first concave part 1213 and the second concave part 1214 are disposed between the fixing structures 108. The fixing structure 108 has clip parts 109 corresponding to the first concave part 1213 and the second concave part 1214, as shown in FIG. 10. A part of the protruding part 107 on the separation barrier 106 is melted and then flows into the first concave part 1213 and the second concave part 1214 to form the clip parts 109. If the concave parts 1213,1214 do not exist, when the first terminal 121 is fixed by the melted part of the protruding part 107, that is the fixing structure 108 can only limits the movement of the terminal along the surface perpendicular to the fixing structure 108. Therefore, the terminal can move along a direction parallel to the fixing structure 108. In other words, the first terminal can move along a front-and-rear direction or an up-and-down direction relative to the insulative body 10, such that the retaining stability of the first terminal on the insulative body 10 is lower. When the melted part flows into the first concave part 1213 and the second concave part 1214 of the first terminal and form a protruding part 1081 meshing with the first terminal, the first terminal can be fixed by the melted part in all directions so as to improve the retaining stability of the first terminal in the insulative body 10 and avoid the vibration of the terminal. The fixing structure 108 on the front side 101 is at the area of the second body part 1221 of the second terminal 122 close to the second connecting part 1220 and at the area of the second contacting part 1222 close to the second body part 1221 respectively. Therefore, the fixing structures 108 fix the first terminal 121 and the second terminal 122 on the insulative body firmly. It should be notice that a cross section of the fixing structure 108 can be a trapezoid, a triangle, a fan, or other shape.

Please refer to the FIG. 11. A stop block 1001 extends from the base 100 of the insulative body 10, and a stop part 1002 is disposed on the stop block 1001. A stop block's surface opposite to the first terminal 121 is inclined to the inserting direction of an external electrical component. As shown in FIG. 11, the inserting direction of the external electrical component is denoted by an arrow A, the extending part of the former surface of the first terminal 121 is denoted by dotted line G. The dotted line G is at an angle with the arrow A, such that the former surface of the first terminal 121 is inclined to the inserting direction of the external electrical component. The conducting arm 12121 extends slantingly from the first body part 1211 toward the stop part 1002.

An extended line of the conducting arm 12121 is denoted by a dotted line H, and the conducting arm 12121 is inclined to the inserting direction of the external electrical component, such that the dotted line H is at an angle with the arrow A. An inclined angle between the dotted line G and the arrow A is smaller than the inclined angle between the dotted line H and the arrow A, so the conducting arm 12121 naturally elastically presses against the stop part 1002 of the stop block 1001. The pressing point between the stop part 1002 and the conducting arm 12121 of the first terminal 121 is located between the conducting part 12122 and the first body part 1211. In this instance, the conducting arm doesn't contact with the whole stop block 1001, therefore, whether the stop block 1001 is flat or not will not affect the flatness of the conducting part 12122 and the function of the electrical connector. It should be noticed that the inserting direction of the external electrical component may can be not the direction A and may be any direction such as direction B within the range from the angle between the contacting part of the first terminal and the contacting point to the angle between contacting part of the second terminal and the contacting point. An inclined angle between the dotted line G and the arrow B is still smaller than the inclined angle between the dotted line H and the arrow B,

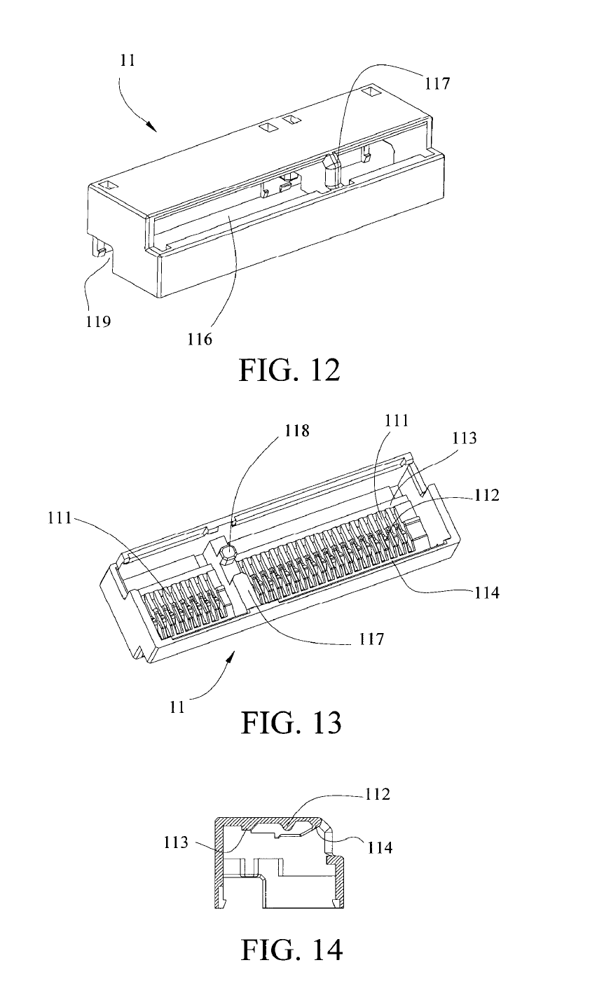

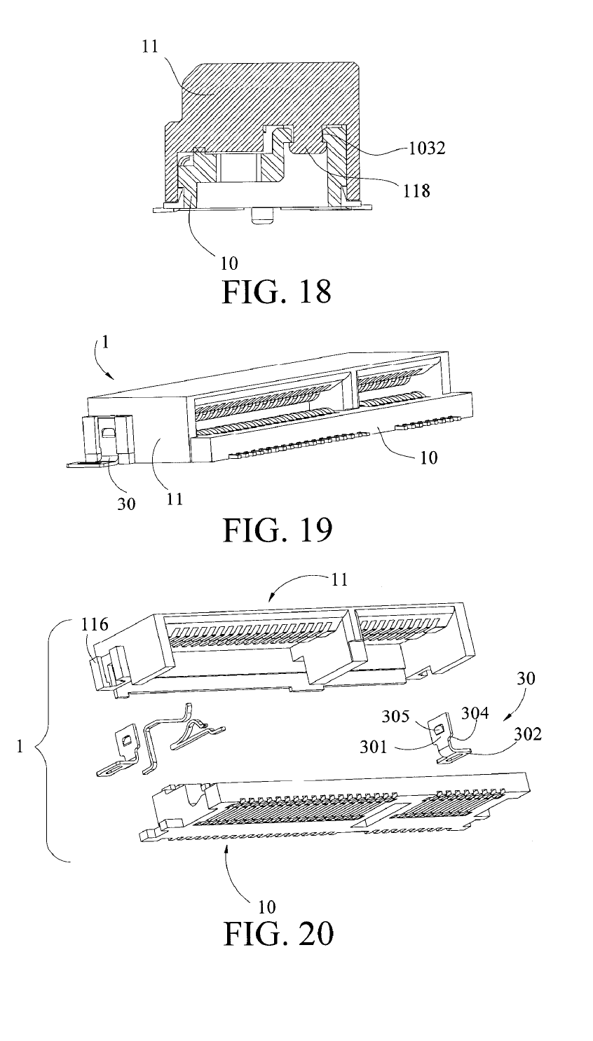

Please refer to FIG. 12-16. The electrical connector further includes a shell 11 mated with the insulative body 10. The separation barriers 106 on the insulative body 10 are the first separation barriers 106, and the second separation barriers 111 corresponding to the first separation barriers 106 are disposed on the internal surface of the shell 11. Moreover, enhancing ribs 112 for enhancing the surface strength of the shell 11 are disposed between the adjacent second separation barriers 111. The enhancing rib's shape 112 corresponds to the shape of the first contacting part of the first terminal 121. As shown in FIG. 17, the apex of the protruding part of the enhancing rib 112 is lower than the highest point of the corresponding first terminal 121. As shown in FIG. 17, the shell 11 has a plurality of recesses 119 corresponding to the first contacting parts 1212, for accommodating the conducting arm 12121 and allowing the conducting part 12122 to move therein. Both sides of the second barriers 111 disposed on the inner surface of the shell 11 are formed with rib-bars 113 and 114 interlaced with the enhancing ribs 112. The enhancing ribs 112 and the rib-bars 113, 114 can effectively enhance the strength of the shell 11, so as to prevent the shell 11 from deforming or cracking in assembling process. One side of the shell 11 has an opening 116, and when the shell 11 mates with the insulative body 10, the two cooperate with each other to form a mating port 20 from which an electrical card (no shown) can insert into. After the electrical card inserts into the mating port, the electrical card electrically connects to the conductive terminals covered by the shell 11 such that realize electrical connection between the electrical card and the electrical connector. A protruding block 117 is disposed on one side of the shell 11 and extends downwardly from the internal surface of the shell to the shell's side having the opening 116. The protruding block 117 is used as a fool-proof device (the fool-proof device also can be disposed on the insulative body). When the shell 11 is assembled on the insulative body 10, the protruding block 117 is accommodated in the receiving passage 1031 of the insulative body 10. The protruding block 117 cooperates with the fool-proof channel (not shown) of the electrical card to prevent a user from mis-inserting. A post 118 extending downwardly from the protruding block 117 can insert into the through channel 1032 in the receiving passage 1031 of the insulative body 10. The post 118 is melted to form a head. The cross section of the head is larger than the cross section of through channel 1032 (as shown in FIG. 16 and FIG. 18), such that, the shell 11 and the insulative body 10 can assemble together to prevent the shell 11 from falling off the insulative body 10 and affecting using performances of the electrical connector. A pressing part for pressing against ends of the contacting parts of the lower row terminals is disposed on the internal surface of the front wall of the shell 11 (as shown in FIG. 17).

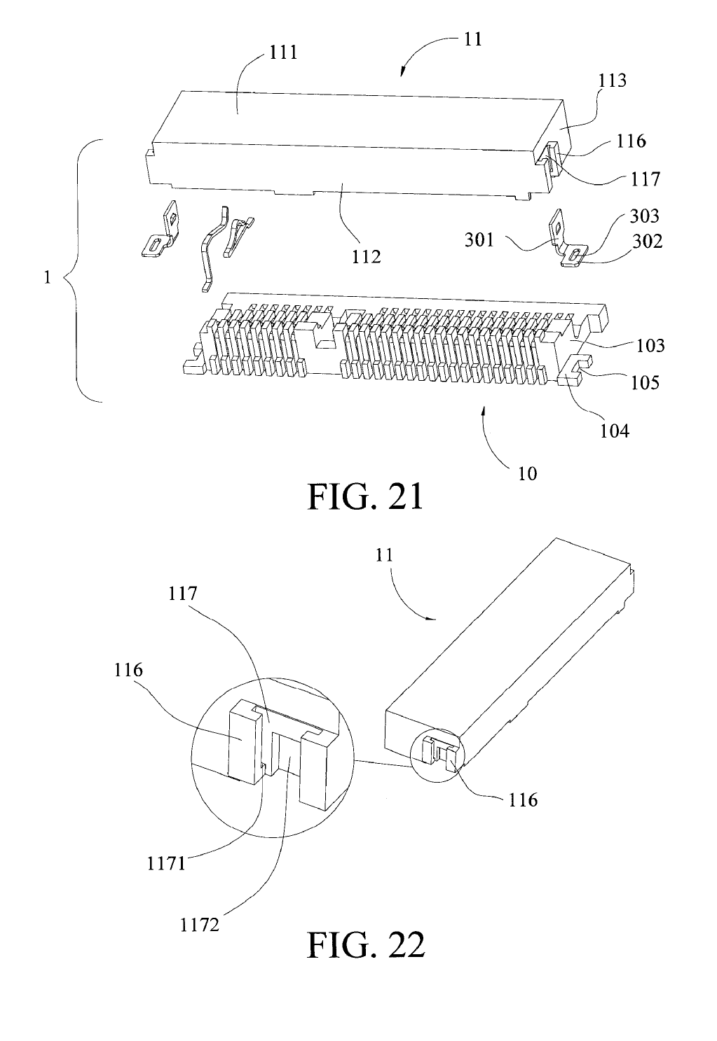

FIG. 19-22 are schematic diagrams illustrating the electrical connector according to the second embodiment of the present invention. Compared with aforesaid embodiment, the whole height of the electrical connector in the second embodiment is lower. The insulative body 10 and the shell 11 of the electrical connector can be together fixed onto the circuit board (not shown) by the fixing device 30. The two end sides 153 of the insulative body 10 respectively have protruding parts 154 extending outwardly with through channel 155. The shell 11 includes a top wall 111 and a back wall 112 extending form back side of the top wall 111. Two ends of the top wall 111 respectively extend downwardly to form two side walls 113. The two side walls 113 respectively extend outwardly to form second protruding parts 116 formed with lock channels 117. Both sides of the lock channels 117 have step planes 1171, so as to make the lock channels 117 a step channels. An internal wall of the lock channels 117 concaves inwardly to form a concave channel 1172. When the shell is assembled on the insulative body 10, the lock channels 117 correspond to the through channels 105 on the insulative body 10. The fixing device 30 includes a base 301. A welding part 302 extends and is bent from the bottom of the base 301. A through hole 303 for accommodating solders (not shown) is disposed in the welding part 302. A step part 304 extends from both sides of the base 301. The step part 304 latches with the step plane 1171 of the lock channels 117 to fix the fixing device onto the shell 11. A protruding barb 305 extends inwardly from a position of the base 301 of the fixing device 30. The position is close to the middle of the base 301. The protruding barb 305 latches with the concave channel 1172 on the internal wall of the lock channels 17. The base 301 threads the lock channel 117 and the through channel 155, and then fixes the shell 11 and the insulative base 10 together. In succession, solder the welding part 302 on the circuit board, such that make the shell 11 and the insulative base 10 fixed onto the circuit board.

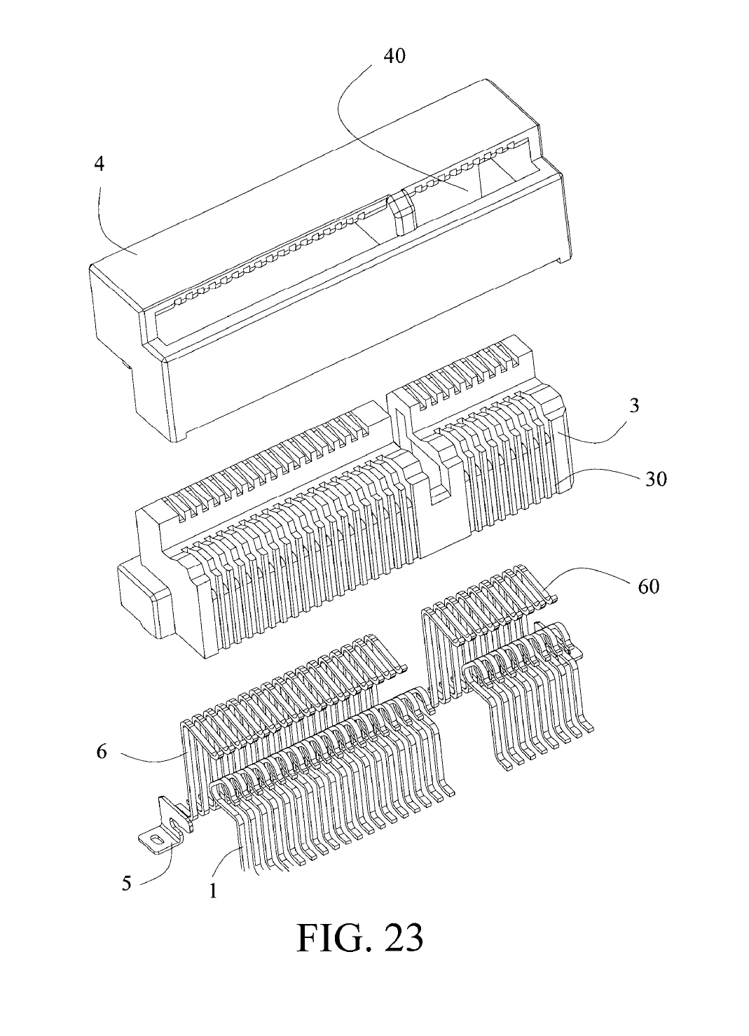

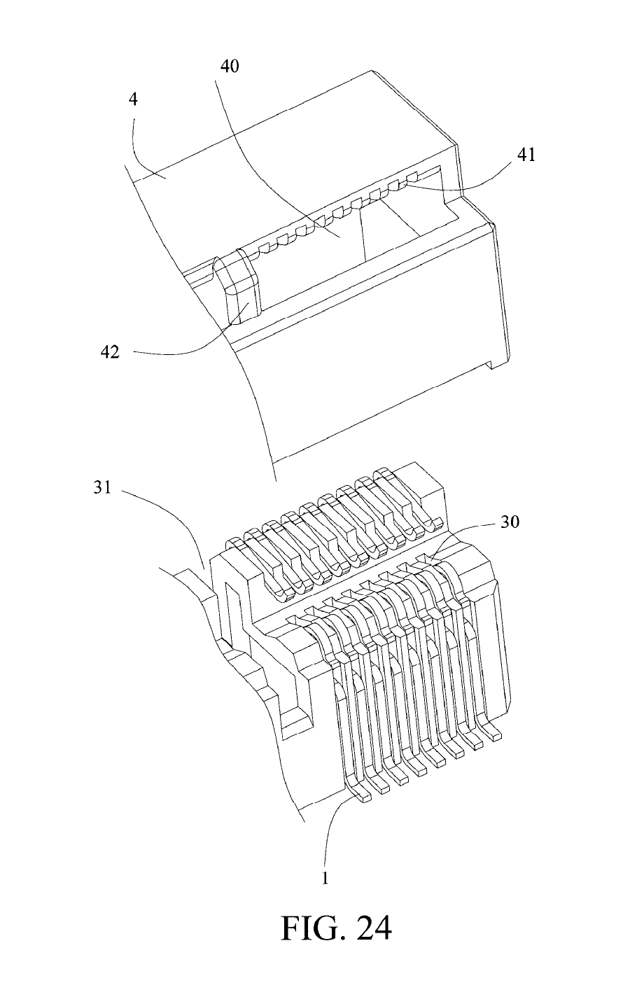

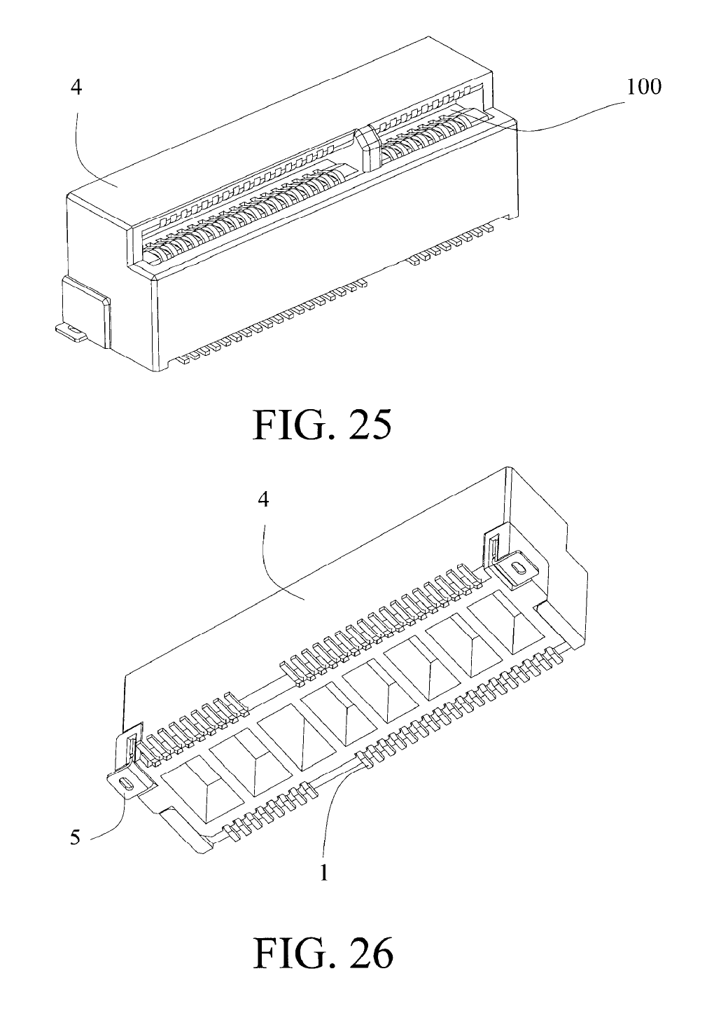

Please refer to FIG. 23-26. FIG. 23-26 are schematic diagrams illustrating the electrical connector according to the third embodiment of the invention. The electrical connector includes an insulative body 3 and conductive terminals. The insulative body has terminal receiving passages 30, and the conductive terminals are accommodated in the terminal receiving passages 30. A shell 4 is disposed outside of the insulative body 3, and the shell 4 can fix the conductive terminals. The shell 4 has protruding ribs 41 cooperating with the terminal receiving passages for pressing against terminals. The shell 4 has an opening 40 and when the shell 11 assembles to the insulative body 3, the two cooperate with each other to form a mating port 100 (as shown in FIG. 3) for an electrical component (not shown). The inserted electric component can electrically connect to the conductive terminals. The insulative body 3 has receiving passages 31. The shell 4 has protrusions 42 corresponding to the receiving passages 31 for positioning the shell 4, and the protrusions 42 forms a fool-proof device. When the shell 4 is assembled on the insulative body 3, the protrusions 42 are accommodated in the receiving passage 31 of the insulative body 3. The protrusions 42 can cooperate with the fool-proof channel (not shown) of the electrical card to prevent a user from mis-inserting the electrical card. The conductive terminals include first conductive terminals 1 and second conductive terminals 6. The first conductive terminal 1 includes a welding part 10 connecting to a material strip, a body part 11 extending and bending upwardly from the welding part 10, a connecting part 13 vertically extending from the body part 11, and a contacting part 12 extending from the connecting part 13.

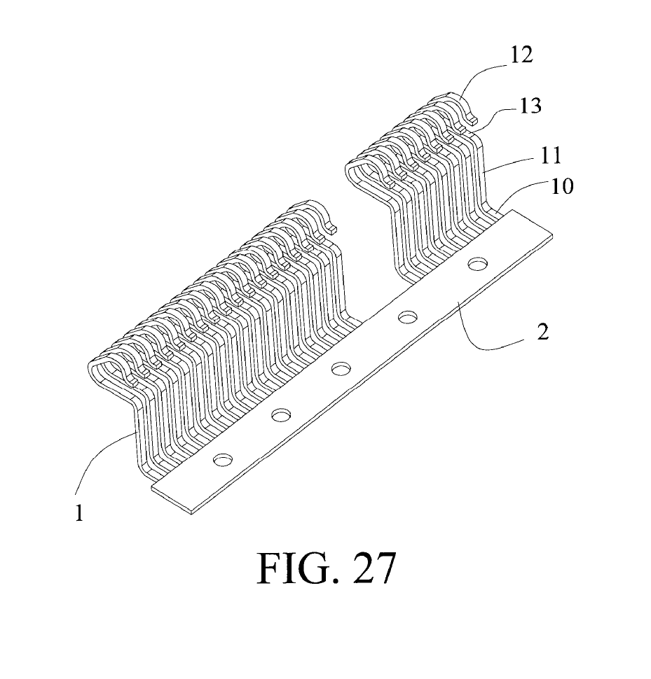

Please refer to FIG. 27, it shows a first terminal blank of electrical connector of the invention. The first terminal blank includes a plurality of conductive terminals 1 and material strips 2 connecting to the first conductive terminals 1 (the structure of the second terminal blank is the same as the first terminal blank's, so it will not be described here again). The first conductive terminal 1 includes a soldering part 10 connecting the material strips 2, a body part 11 bended and extending upwardly from the soldering part 10, a connecting part 13 extending vertically from the body part 11, and a contacting part 12 extending from the connecting part 13. An angle between the first conductive terminal 1 and the material strips 2 are smaller than or equal to 90 degrees. In this embodiment, the degree is ninety. That is, the soldering part 10 of the conductive terminal 1 is perpendicular to the material strips 2. A method of assembling the electrical connector includes the following steps: 1. providing the aforesaid terminals; 2. providing the insulative body 3 for accommodating the conductive terminal, the shell 4 for fixing the conductive terminals, and terminal blanks formed by pressing and bending, wherein the insulative body 3 has terminal receiving passages 30; 3. disposing the conductive terminals of the terminal blanks into corresponding terminal receiving passages 30 of the insulative body 3; 4. assembling the shell 4 on the insulative body 3 for pressing and fixing the conductive terminals by the protruding ribs 41 of the shell 4, and then removing the material strips 2; and 5. assembling the fixing piece 5 on the insulative body 3, and fixing the electrical connector by the fixing piece 5. The method of assembling the electrical connector can raise assembling efficiency. Because the design of the structure of the electrical connector in the invention is not to fix the conductive terminals on the fixing part of the insulative body, the conductive terminals need not press forcedly into the insulative body, such that the zero-insertion force assembling of the terminals can be realized and the conductive terminals are not deformed during the insertion into the insulative body. Therefore, the electrical connector can function better.

What is claimed is:

1. An electrical connector, comprising:
a plurality of conductive terminals;
an insulative body having a plurality of terminal receiving passages accommodating the conductive terminals; and
a shell cooperating with the insulative body to form a mating port.

2. The electrical connector of claim 1, wherein the shell has a fool-proof device for preventing from mis-inserting of an electrical card.

3. The electrical connector of claim 2, wherein the insulative body has a receiving passage accommodating the fool-proof device.

4. The electrical connector of claim 1, wherein the insulative body has a fool-proof device for preventing from mis-inserting of an electrical card.

5. The electrical connector of claim 1, wherein the insulative body has a through channel with a cross section, the shell has a post passing through the through channel and a head disposed on an end of the post and being larger than the cross section of the through channel.

6. The electrical connector of claim 1, wherein each conductive terminal has a contacting part comprising a body part, a conducting arm extending from the body part, and a conducting part bending and extending from the conducting arm, and a wall of the shell corresponding to the contacting part has a plurality of enhancing ribs corresponding to the conducting arms.

7. The electrical connector of claim 6, wherein an apex of a protruding part of each enhancing rib is lower than a highest point of the contacting part of the corresponding conductive terminal.

8. The electrical connector of claim 6, wherein the enhancing ribs and a plurality of rib-bars interlaced with the enhancing ribs are disposed on an internal surface of the shell.

9. The electrical connector of claim 6, wherein the wall of the shell corresponding to the contacting part has a plurality of separation barriers for separating the conductive terminals.

10. The electrical connector of claim 1, wherein the conductive terminal has a contacting part comprising a body part, a conducting arm extending from the body part, and a conducting part bending and extending from the conducting arm, and a wall of the shell corresponding to the contacting part has recesses accommodating the conducting arms and allowing the conducting parts to move therein.

11. The electrical connector of claim 10, wherein the wall of the shell corresponding to the contacting part has a plurality of separation barriers for separating the conductive terminals.

12. The electrical connector of claim 1, wherein the electrical connector has a fixing device, the fixing device passes through the insulative body and the shell and fixes the insulative body and the shell.

13. The electrical connector of claim 12, wherein the shell and the insulative body have a lock channel and a through channel corresponding to the lock channel, and the lock channel and the through channel match the fixing device.

14. The electrical connector of claim 1, wherein the conductive terminal comprises a connecting part, a body part extending from the connecting part, and a contacting part extending from the body part, and the shell has a pressing part pressing an end of the contacting part.
